(19) United States
(12) Patent Application Publication
(10) Pub. No.: US 2005/0050567 A1
(43) Pub. Date: Mar. 3, 2005

(54) Disk drive unit

(76) Inventors: Shinya Takizawa, Ueda-shi (JP); Toyoki Yamamoto, Ueda-shi (JP); Makoto Aida, Ueda-shi (JP)

Correspondence Address: BIRCH STEWART KOLASCH & BIRCH, PO BOX 747, FALLS CHURCH, VA, 22040-0747, US

(21) Appl. No.: 10/921,174

(22) Filed: Aug. 19, 2004

(30) Foreign Application Priority Data
Aug. 29, 2003 (JP) 2003-306995

(51) Int. Cl. G11B 17/03

(52) U.S. Cl. 720/655

(57) ABSTRACT

The disk drive unit is capable of restraining deformation and vibrations of a disk medium without enlarging size and increasing weight. The disk drive unit, which rotates the disk medium so as to read data from and/or write data in the disk medium, comprises: a pick-up for reading data from and/or write data in the disk medium, the pick-up moving in a prescribed direction; and a top case for covering over an upper face of the disk medium, the top case having an inner face, from which a projection is projected toward the disk medium in the direction perpendicular to the prescribed direction.

### BACKGROUND OF THE INVENTION

The present invention relates to a disk drive unit for rotating a disk medium such as an optical disk (e.g., CD, DVD), a magnetic-optical disk (MO), a magnetic disk.

For example, in a disk drive unit of a conventional optical disk player, an optical disk, e.g., CD, DVD, is rotates so as to read and/or write data by a spindle motor. The disk drive unit includes an optical pick-up, which is capable of irradiating a laser beam toward a data recording face of the optical disk and/or receiving a reflected beam therefrom so as to read and/or write data.

A direction of irradiating the laser beam is perpendicular to the data recording face of the optical disk. However, these days, the optical disk is rotated at high speed, so that the optical disk is warped upward or downward. Further, in some cases, the optical disk is vibrated during rotation.

If the optical disk is deformed, the laser beam cannot be irradiated perpendicular to the data recording face, so that quality of data read from or written in the optical disk must be worse.

To solve the above described problems of the conventional disk drive unit, some technical ideas have been studied.

For example, Japanese Patent Gazette No. 2000-357385A disclosed a disk drive unit, in which both side faces of an optical disk are sandwiched by projected circles, which are concentrically arranged.

According to Japanese Patent Gazette No. 2000-357385A, deformation and vibrations of the optical disk are caused by the following reason. Namely, air around the optical disk is moved from an inner part of the optical disk to an outer part thereof, with rotation of the optical disk, by a centrifugal force, so that a pressure difference is generated between the inner part and the outer part. By the pressure difference, the air concentrically flows. The air flow does not circularly flow, namely it is snaked through the disk drive unit by an internal shape of the disk drive unit. Therefore, the snaked air flow causes the deformation and the vibrations of the optical disk.

In the disk drive unit disclosed in Japanese Patent Gazette No. 2000-357385A, the projected circles are provided on the both sides of the optical disk so as to restrain the travel of the air and prevent the pressure difference. With this structure, the deformation and the vibrations of the optical disk can be restrained.

However, in the disk drive unit disclosed in Japanese Patent Gazette No. 2000-357385A, the projected circles must be provided on the both sides of the optical disk, so that the structure of the disk drive unit must be complex, number of parts must be increased and manufacturing cost of the disk drive unit must be increased.

Further, the disk drive unit must be large and heavy. The large and heavy disk drive unit cannot be assembled in a compact disk player.

### SUMMARY OF THE INVENTION

An object of the present invention is to provide a disk drive unit, which is capable of restraining deformation and vibrations of a disk medium without enlarging size and increasing weight.

To achieve the object, the present invention has following structures.

Namely, the disk drive unit of the present invention, which rotates a disk medium so as to read data from and/or write data in the disk medium, comprises:

a pick-up for reading data from and/or write data in the disk medium, the pick-up moving in a prescribed direction; and

a top case for covering over an upper face of the disk medium, the top case having an inner face, from which a projection is projected toward the disk medium in the direction perpendicular to the prescribed direction.

With this structure, the projection divides an inner space into to two parts: a front part, which includes a disk insertion port of a front panel; and a rear part, which includes an inner end of a moving track of the pick-up. Therefore, the projection blocks an air flow between the two parts, so that a circular air flow, which flows in the circumferential direction, is not generated. By preventing the circular air flow, no snaking air flow is generated in the disk drive unit, so that deformation and vibrations of the disk medium can be prevented.

In the disk drive unit, the projection may be located at a position, which is on a line perpendicular to the prescribed direction, which is on the opposite side of the pick-up with respect to the center thereof and which is separated about 6 mm away from the center thereof. For example, in the case that the pick-up moves back and forth and its moving track is located on the rear side of the center of the disk medium, the projection is located at the position, which is forwardly shifted 6 mm from the center of the disk medium. With this structure, the air flow in the disk drive unit can be effectively blocked, so that the deformation of the disk medium can be prevented.

A preferable projected length of the projection from the inner face of the top case is about 1 mm.

A preferable width of the projection, which is parallel to the prescribed direction, is 10-12 mm.

In the disk drive unit, an end of the projection, which is in the direction perpendicular to the prescribed direction, may be extended to an outer edge of the disk medium.

In the disk drive unit, the projection may be made of rubber sponge and attached to the top case.

In the disk drive unit, the top case may have an opened-concave section, which is concaved toward the disk medium so as to accommodate a chucking pulley holding the disk medium and which has a hole so as to project a center part of the chucking pulley toward the disk medium; a pair of the projections may be provided on the opposite sides with respect to the opened-concave section; and inner ends of the projections may contact an outer edge of the opened-concave section. With this structure, even if the opened-concave section is formed to accommodate the chucking pulley, the projected sections can be formed on the both sides of the opened-concave section, so that the deformation of the disk medium can be prevented.

In the disk drive unit, a second projection may be projected from the inner face of the top case toward an outer end of the disk medium, which corresponds to an inner end of a moving track of the pick-up, in the direction perpendicular to the moving track. By employing the second projection, the deformation of the disk medium can be securely prevented.

A preferable projected length of the second projection from the inner face of the top case is about 3 mm, and a preferable width of the second projection, which is parallel to the prescribed direction, is about 4 mm. With this structure, the deformation of the disk medium can be effectively prevented.

### BRIEF DESCRIPTION OF THE DRAWINGS

Embodiments of the present invention will now be described by way of examples and with reference to the accompanying drawings, in which:

FIG. 1 is an exploded perspective view of a disk drive unit of a first embodiment;

FIG. 2 is a sectional view taken along a line A-A shown in FIG. 1;

FIG. 3 is a sectional view taken along a line B-B shown in FIG. 1;

FIG. 4 is a plan view of the disk drive unit;

FIG. 5 is a perspective view of a top case seen from a lower side;

FIG. 6 is a bottom view of the top case;

FIG. 7 is a bottom view of a top case of a second embodiment;

FIG. 8 is a graph showing relationships between rotational speed of an optical disk, deformation thereof, etc.;

FIG. 9 is a graph of relationships between a length of a projection, deformation of the optical disk, etc.;

FIG. 10 is a graph of relationships between a width of the projection, deformation of the optical disk, etc.;

FIG. 11 is a graph of relationships between an arrangement of the projection, deformation of the optical disk, etc.;

FIG. 12 is a graph of relationships between an existence of projections, deformation of the optical disk, etc.;

FIG. 13 is a graph of relationships between a position of the projection, deformation of the optical disk, etc.

### DETAILED DESCRIPTION OF THE EMBODIMENTS

Preferred embodiments of the present invention will now be described in detail with reference to the accompanying drawings.

The disk drive unit of the present invention has a simple structure capable of blocking air flow, which is caused by rotation of a disk medium, in the disk drive unit.

The present invention can be applied to not only optical disk drive units, e.g., CD drive units, DVD drive units, but also magnetic-optical disk drive units, magnetic disk drive units, etc.

### First Embodimetn

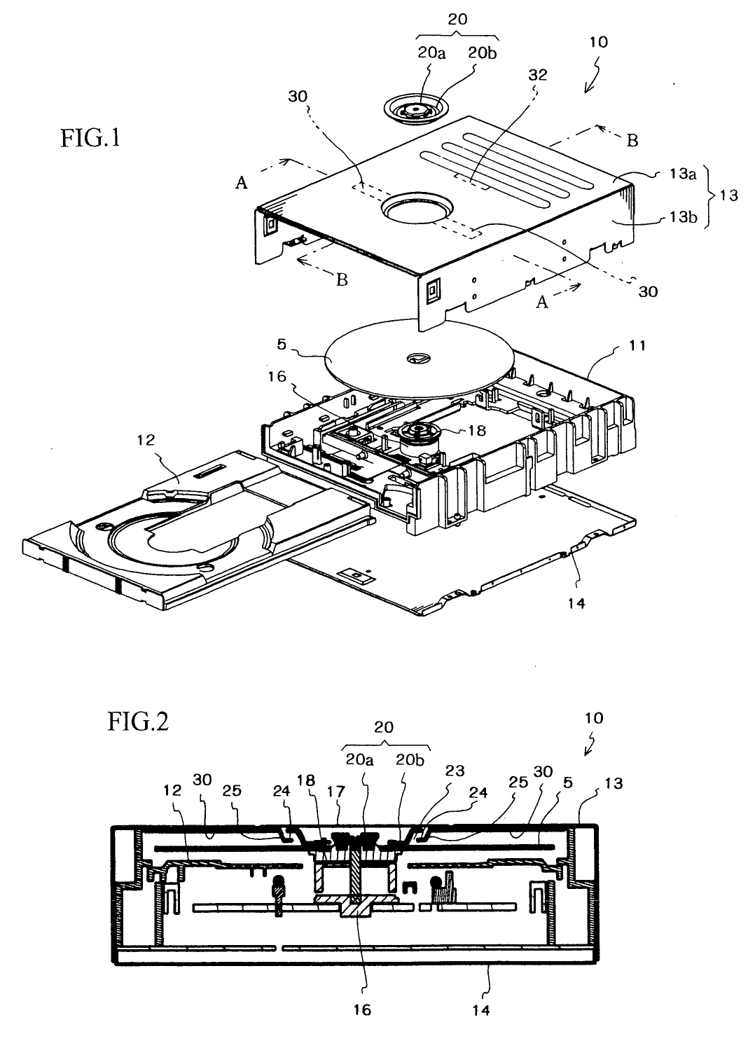

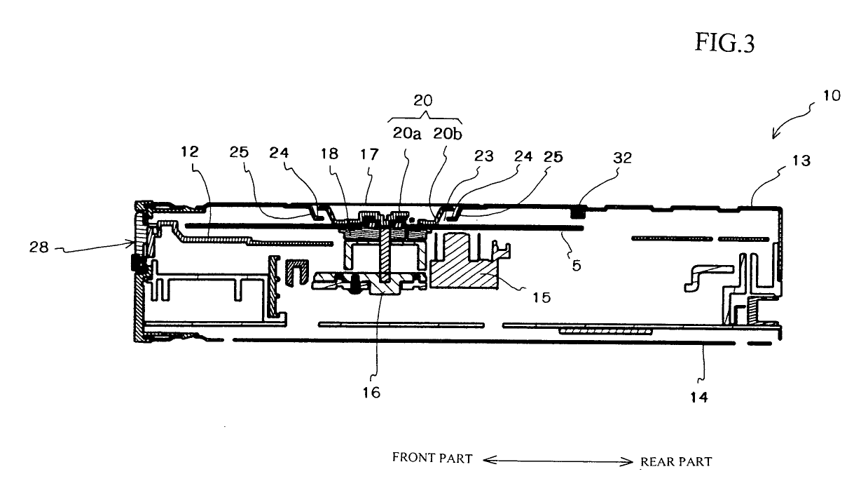

An exploded perspective view of an optical disk drive unit of the first embodiment, which is capable of driving an optical disk, e.g., CD, DVD, is shown in FIG. 1. FIG. 2 is a sectional view of the optical disk drive unit taken along a line A-A shown in FIG. 1; FIG. 3 is a sectional view thereof taken along a line B-B shown in FIG. 1.

The optical disk drive unit 10 includes: a body section 11; a tray 12, on which the optical disk 5 is mounted and which can be projected from and retracted into the body section 11; a top case 13 covering over an upper part of the body section 11; and a bottom case covering a lower part of the body section 11. A spindle motor 16, which rotates the optical disk 5, an optical pick-up 15, which is an example of a pick-up and which is capable of irradiating a laser beam toward the optical disk 5, etc. are accommodated in the body section 11.

A turn table 18, on which the optical disk 5 will be mounted, is connected to an upper end of a spindle of the spindle motor 16. The optical disk 5 will be held between the turn table 18 and a chucking pulley 20.

The chucking pulley 20 is provided on an upper face of the top case 13. A magnet is accommodated in a center part 20a of the chucking pulley 20, so that the chucking pulley 20 is biased toward the turn table 18 by the magnetic force. With this structure, the chucking pulley 20 can be detachably attached to the upper end of the turn table 18.

The chucking pulley 20 has an outer peripheral part 20b, which is formed on the outer side of the center part 20a and whose thickness is thinner than that of the center part 20a. The outer peripheral part 20b has no magnet and does not contact the turn table 18.

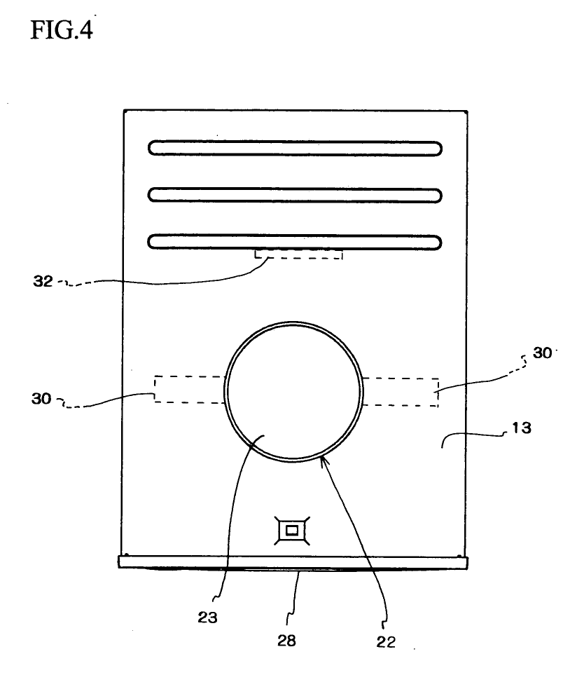

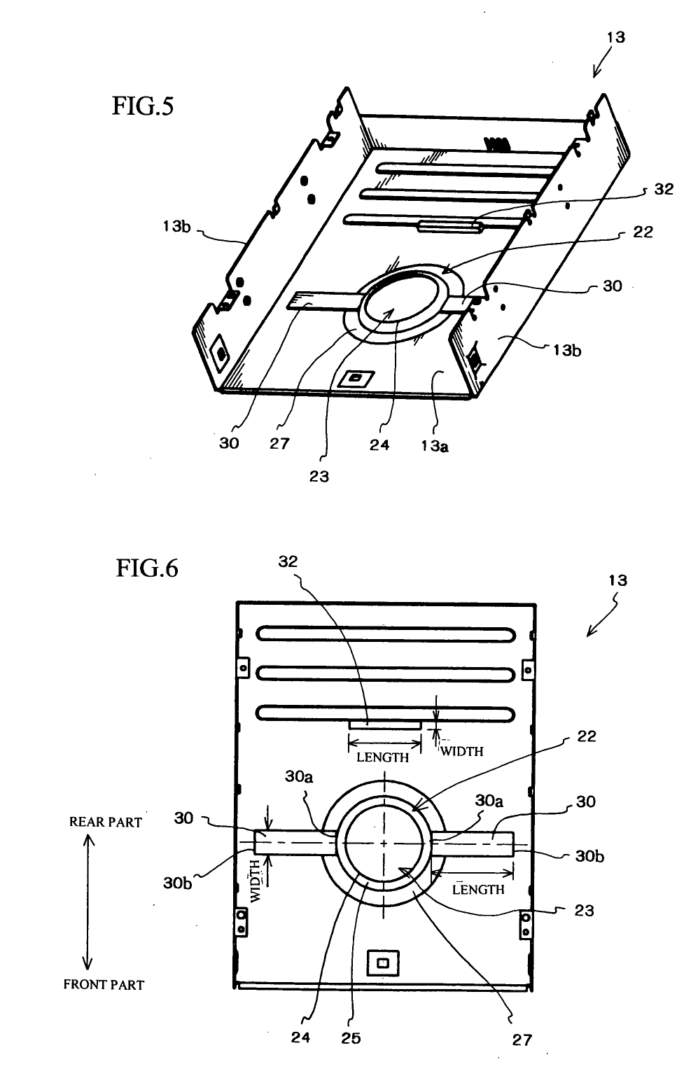

FIG. 4 is a plan view of the top case 13; FIG. 5 is a perspective view of the inside of the top case 13 seen from a lower side; and FIG. 6 is a bottom view of the top case 13.

In the present embodiment, the top case 13 is made of a metal. A top plate 13a located above the optical disk 5 and side walls 13b covering both sides of the body section 11 are integrated.

An opened-concave section 22, on which the chucking pulley 20 is mounted, is formed at a center of the top plate 13a of the top case 13. The opened-concave section 22 is capable of completely accommodating the chucking pulley 20 therein. A through-hole 23 is formed in a center part of the opened-concave section 22, so that the center part 20a of the chucking pulley 20 can be projected downward from a lower face of the top case 13 through the hole 23.

An outer edge 20b of the chucking pulley 20 can be mounted on an edge 24 of the hole 23. A female tapered section 25 is formed around the hole 23, and a diameter of the female tapered section 25 is gradually made greater toward the upper face of the top case 13.

A cover 17 is capable of closing the opened-concave section 22 so as not to detach the chucking pulley 20 from the opened-concave section 23 or the top case 13 (see FIGS. 2 and 3). A circular step section 24 is formed along the edge of the opened-concave section 22. By forming the circular step section 24, the upper face of the top plate 13a becomes flat when the cover 17 is fitted with the circular step section 24. Namely, depth of the circular step section 24 is equal to thickness of the cover 17.

A pair of projections 30 are projected toward the optical disk 5 from an inner or lower face of the top plate 13a of the top case 13. The projections 30 prevents deformation, e.g., warp, of the optical disk 5 while the optical disk 5 is rotated.

In the present embodiment, a planar shape of each projection 30 is formed into a rectangular shape. A longitudinal direction of each projection 30 is arranged perpendicular to a moving track of the optical pick-up 15; a transverse direction of each projection 30 is arranged parallel to the moving track thereof. Note that, the optical pick-up 15 is moved in the radial direction of the optical disk 5 or moved toward the front end and the rear end of the body section 11. The center of the optical disk 5 is located on a line extended from the projections 30 in the longitudinal directions.

The projections divide an inner space of the disk drive unit 10 into to two parts: a front part, which includes a disk insertion port 28 of a front panel; and a rear part, which is on the opposite side of the front part with respect to the projections 30.

In the present embodiment, each projection 30 is made of rubber sponge and has thickness of 1 mm, width of 12 mm and length of 40 mm. A pair of the rubber sponges are adhered on the lower face of the top plate 13a by two-sided tape so as to form the projections 30.

Since the rubber sponges cannot be adhered in the hole 23 of the opened-concave section 22, the projections 30 are respectively formed on the both sides of the hole 23.

Inner ends 30a of the projections 30 contact an inner or lower face of the female tapered section 25. On the other hands, outer ends 30b of the projections 30 reach an outer edge of the optical disk 5.

As shown in the drawings, a second projection 32 may be further provided to the top case 13. In the present embodiment, the second projection 32 is arranged in the direction perpendicular to the moving track of the optical pick-up 15 and corresponds to an inner end of the optical disk 5. The second projection 32 is made of rubber sponge and has thickness of 3 mm, width of 4 mm and length of 35 mm. The rubber sponge is adhered on the lower face of the top plate 13a by two-sided tape so as to form the second projection 32.

In the present embodiment, the opened-concave section 22, whose center corresponds to the center of the optical disk 5, is formed in the top plate 13a of the top case 13, the projections 30 are arranged in the direction perpendicular to the moving track of the optical pick-up 15 and respectively provided on the both sides of the opened-concave section 22. If the top case 13 has no opened-concave section, one projection 30 may be formed in the direction perpendicular to the moving track of the optical pick-up 15.

### Second Embodiment

In the First Embodiment, the top case 13 has two projections 30, and the center of the optical disk 5 is located on the line extended from the projections 30 in the longitudinal directions.

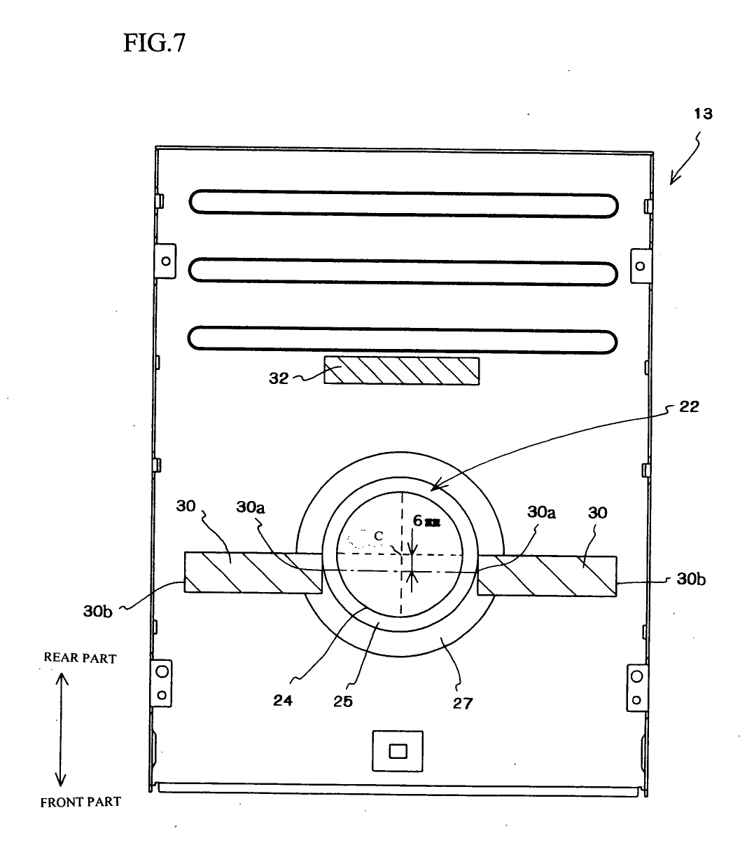

In the present embodiment, as shown in FIG. 7, two projections 30 are shifted toward a part, in which the optical pick-up 15 does not exist. For example, the projections 30 are respectively provided on the both sides of the opened-concave section 22 and shifted forward (toward the front panel) 6 mm from the center C of the optical disk 5. With this structure, the deformation of the optical disk 5 during rotation can be prevented.

The second projection 32 is provided as well as the First Embodiment.

In the First and Second Embodiments, the projections 30 and the second projections 32 are made of rubber sponge, but a material of the projections 30 and 32 are not limited to rubber sponge. They may be made of metals, plastics, etc.

In the First and Second Embodiments, the projections 30 and the second projections 32 are adhered to the top case 13, but they may be integrated with the top case 13.

### Experiments

Experiments for verifying effects of the present invention will be explained. Note that, the optical disk player shown in FIGS. 1-3 was used in the experiments.

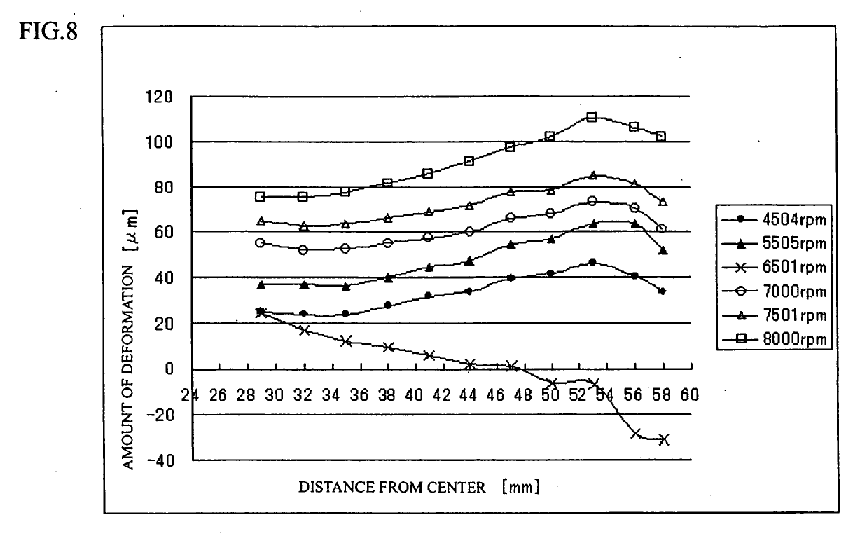

A graph showing relationships between the rotational speed of the optical disk (unit: rpm) and the deformation thereof (unit: μm) is shown in FIG. 8. When the optical disk was rotated at rotational speed of 1300 rpm, an amount of deformation of the optical disk was regarded as zero. The graph shows the vertical deformation of the optical disk with respect to positions in the optical disk and the rotational speeds. Note that, the optical disk player had no projections in the top case.

According to the graph of FIG. 8, the amount of the deformation was maximized at the position 53 mm separated from the center of the disk without reference to the rotational speeds. When the rotational speed was 4500-8000 rpm, the deformation was increased with accelerating the rotational speed, but the disk was warped downward at the rotational speed of 6500 rpm.

Therefore, the amount of the deformation can be reduced by reducing the rotational speed.

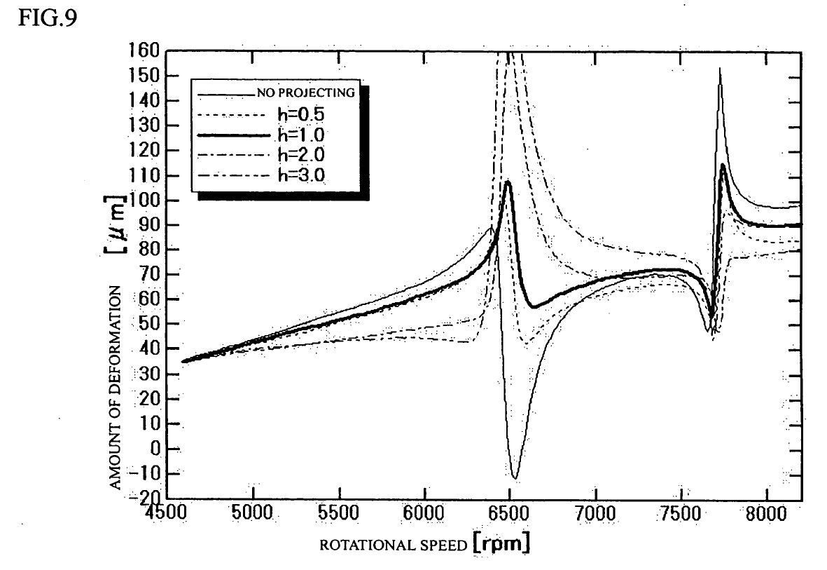

FIG. 9 shows a graph of the amount of the vertical deformation (unit: μm) of a part of the disk, which was 55 mm separated from the center, with respect to the rotational speeds (unit: rpm) and the length “h” of the projections (unit: mm).

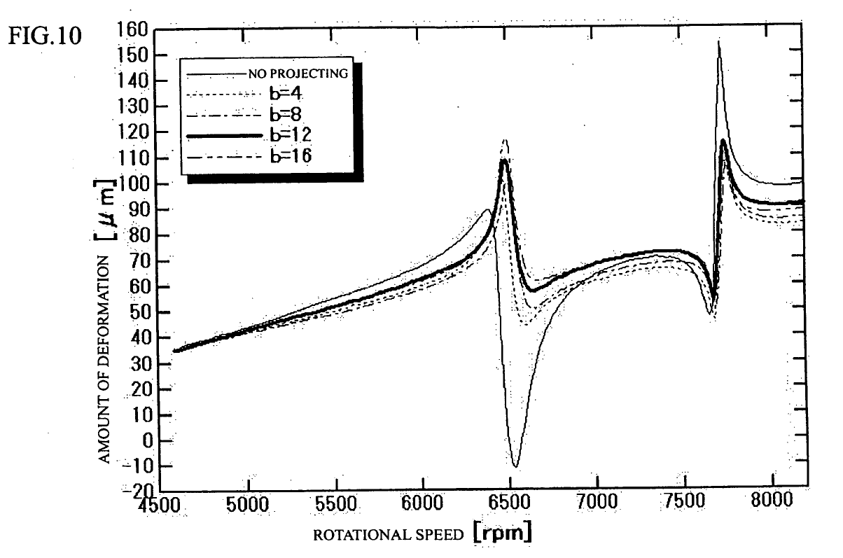

FIG. 10 shows a graph of the amount of the vertical deformation (unit: μm) of the part of the disk, which was 55 mm separated from the center, with respect to the rotational speeds (unit: rpm) and the width “b” of the projections (unit: mm).

In the graphs of FIGS. 9-14, horizontal axes show the rotational speeds of the optical disk (unit: rpm). In the optical disk drive unit, the rotational speed of the disk was CLV (Constant Linear Velocity)-controlled. Therefore, the rotational speed of the disk was 8300 rpm when the optical pick-up corresponded to the innermost part of the disk; the rotational speed of the disk was 4500 rpm when the optical pick-up corresponded to the outermost part of the disk. Note that, the amount of the vertical deformation of the optical disk was regarded as zero when the optical disk was rotated at the rotational speed of 1300 rpm as well as FIG. 8. A vertical level of the disk when it was rotated at 1300 rpm was regarded as a standard level. Namely, the amount of the vertical deformation was a vertical distance from the standard level.

According to the graphs, if no projections were provided, the deformation of the disk was upwardly maximized (about 155 μm) at 7700 rpm and downwardly maximized (about 10 μm) at 6500 rpm. Namely, in one optical disk, the deformation was changed upwardly and downwardly.

By employing the projections having thickness of 1.0 mm and width of 12 mm, the upward warp was reduced to about 115 μm (−26%) at 7700 rpm; the disk was warped upward about 55 μm (+550%) at 6500 rpm.

At the rotational speed of 6500 rpm, the amount of the deformation was increased, but the reverse deformation could be solved. Namely, the disk was deformed in one direction. Further, rate of varying amount of the deformation could be small. Therefore, various corrections, e.g., focus correction of the optical pick-up, can be easily performed.

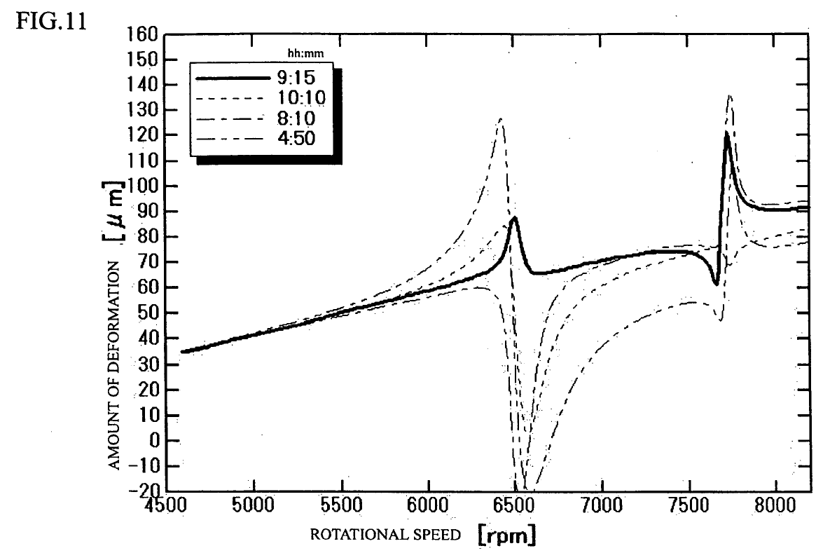

FIG. 11 shows a graph of the amount of the vertical deformation (unit: μm) of the part of the disk, which was 55 mm separated from the center, with respect to the rotational speeds (unit: rpm) and arrangements of the projections. The arrangements of the two projections were regarded as an hour hand and a minute hand of a clock. Namely, a direction toward the front end of the optical disk drive unit was 12 o'clock; a direction toward the rear end thereof was 6 o'clock. The projections were arranged at positions “hh:mm” of 9:15, 10:10, 8:10 and 4:50.

According to the graph, when the projections were arranged at the position 9:15, at which the projections were perpendicular to the moving track of the optical pick-up, the reverse deformation could be solved. Namely, the disk was deformed in one direction, and the rate of varying amount of the deformation could be small. Therefore, various corrections, e.g., focus correction of the optical pick-up, can be easily performed.

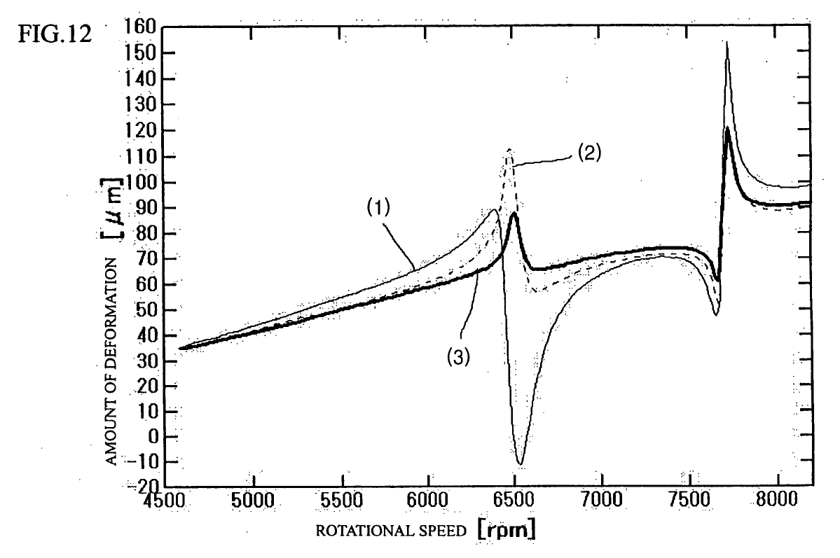

FIG. 12 shows a graph of the amount of the vertical deformation (unit: μm) of the part of the disk, which was 55 mm separated from the center, with respect to the rotational speeds (unit: rpm) and an existence of the projections (thickness: 1.0 mm, width: 12 mm) and the second projection (thickness: 3.0 mm, width: 4 mm, length: 35 mm, material: rubber sponge), which was provided on the rear side of the projections.

According to the graph, around the rotational speed of 6500 rpm, amount of the deformation of a sample (2), which had the projections, was greater than those of a sample (1), which had no projections, and a sample (3), which had the projections and the second projection. The amount of deformation of the sample (3) is almost equal to that of the sample (1). Therefore, by employing the projections and the second projection, the deformation of the disk could be effectively restrained.

Further, the reverse deformation could be solved, so that, the disk was deformed in one direction, and the rate of varying amount of the deformation could be small. Therefore, various corrections, e.g., focus correction of the optical pick-up, can be easily performed.

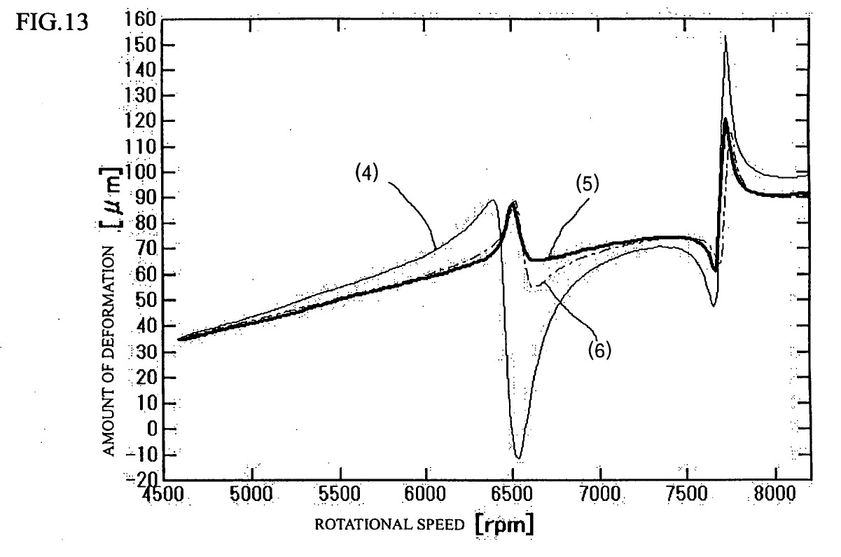

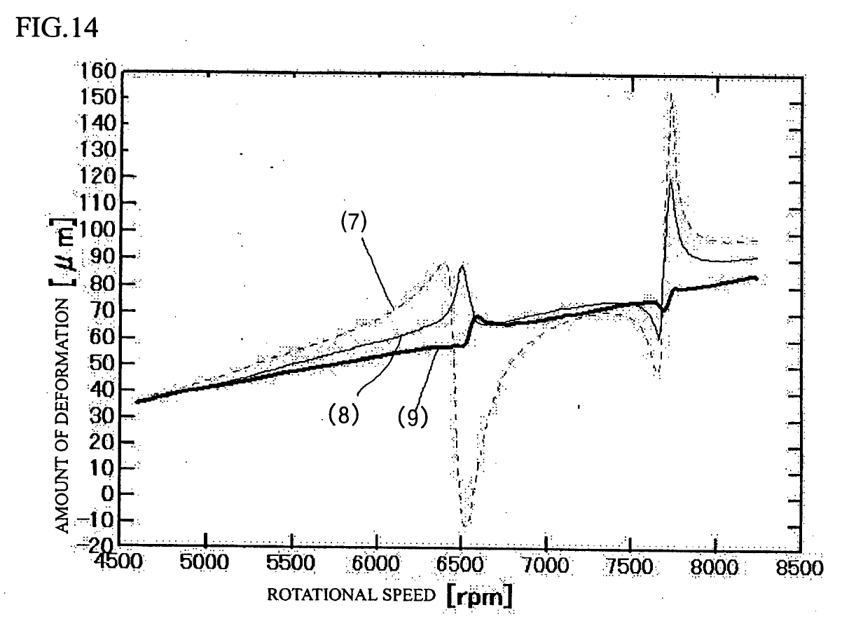

FIG. 13 shows a graph of the amount of the vertical deformation (unit: μm) of the part of the disk, which was 55 mm separated from the center, with respect to the rotational speeds (unit: rpm) and materials of the projections and the second projections. Each of the samples (5) and (6) has the projections and the second projection. The sample (4) had no projections and no second projection; the projections of the sample (5) were made of rubber sponge; and the projections of the sample (6) were made of plastic.

According to the graph, the amount of the deformation of the plastic projection (including the second projection) was smaller than that of the rubber sponge projection; rate of varying amount of the deformation of the plastic projection was greater than that of the rubber sponge projection. Therefore, the plastic projection is not suitable for correcting the deformation of the disk. Namely, the plastic projections may be used for the disk drive unit, but functions of the rubber sponge is better than plastic.

FIG. 14 shows a graph of the amount of the vertical deformation (unit: μm) of the part of the disk, which was 55 mm separated from the center, with respect to the rotational speeds (unit: rpm) and positions of the projections. Each of the samples (8) and (9) has the projections and the second projection (length: 3 mm), but the position of the second projection is fixed. The sample (7) had no projections and no second projection; the projections of the sample (8) were located on a line passing the center of the disk (see FIG. 6); and the projections of the sample (9) were located at positions, which were on a line perpendicular to the prescribed direction, which is on the opposite side (the front side) of the pick-up with respect to the center C thereof and which is separated about 6 mm away from the center C thereof (see FIG. 7).

According to the graph, the upward deformation of the sample (9), in which the projections were shifted forward 6 mm, was about 60 mm at 7700 rpm, and the upward deformation was about 70 mm at 6500 rpm. Rate of varying amount of the deformation was very small. Therefore, the sample (9) could well prevent the deformation of the disk.

As described above, the disk drive unit of the present invention has the simple structure and is capable of effectively preventing the deformation of the disk medium without enlarging size of the disk drive unit, increasing weight and manufacturing cost thereof. By preventing the deformation of the disk, quality of data read from and written in the disk medium can be increased. Especially, the deformation of the disk medium around the rotational speeds of 7700 rpm and 6500 rpm can be effectively prevented.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A disk drive unit, which rotates a disk medium so as to read data from and/or write data in the disk medium,
comprising:
a pick-up for reading data from and/or write data in the disk medium, said pick-up moving in a prescribed direction; and
a top case for covering over an upper face of the disk medium, said top case having an inner face, from which a projection is projected toward the disk medium in the direction perpendicular to the prescribed direction.

2. The disk drive unit according to claim 1,
wherein said projection is located at a position, which is on a line perpendicular to the prescribed direction and which is on the opposite side of said pick-up with respect to the center thereof and which is separated about 6 mm away from the center thereof.

3. The disk drive unit according to claim 1,
wherein a projected length of said projection from the inner face of said top case is about 1 mm.

4. The disk drive unit according to claim 1,
wherein a width of said projection, which is parallel to the prescribed direction, is 10-12 mm.

5. The disk drive unit according to claim 1,
wherein an end of said projection, which is in the direction perpendicular to the prescribed direction, reaches an outer edge of the disk medium.

6. The disk drive unit according to claim 1,
wherein said projection is made of rubber sponge and attached to said top case.

7. The disk drive unit according to claim 1,
wherein said top case has an opened-concave section, which is concaved toward the disk medium so as to accommodate a chucking pulley holding the disk medium and which has a hole so as to project a center part of the chucking pulley toward the disk medium,
a pair of said projections are provided on the opposite sides with respect to the opened-concave section, and
inner ends of said projections contact an outer edge of the opened-concave section.

8. The disk drive unit according to claim 1,
wherein a second projection is projected from the inner face of said top case toward an outer end of the disk medium, which corresponds to an inner end of a moving track of said pick-up, in the direction perpendicular to the moving track.

9. The disk drive unit according to claim 8,
wherein a projected length of said second projection from the inner face of said top case is about 3 mm.

10. The disk drive unit according to claim 8,
wherein a width of said second projection, which is parallel to the prescribed direction, is about 4 mm.

11. The disk drive unit according to claim 9,
wherein a width of said second projection, which is parallel to the prescribed direction, is about 4 mm.

12. The disk drive unit according to claim 8,
wherein a length of said second projection, which is perpendicular to the prescribed direction, is 35 mm or more.

13. The disk drive unit according to claim 9,
wherein a length of said second projection, which is perpendicular to the prescribed direction, is 35 mm or more.

14. The disk drive unit according to claim 10,
wherein a length of said second projection, which is perpendicular to the prescribed direction, is 35 mm or more.
